(19) United States
(12) Patent Application Publication
(10) Pub. No.: US 2012/0011793 A1
(43) Pub. Date: Jan. 19, 2012

(54) Adhesion Enhanced Insulated Framing Member

(75) Inventors: Dennis Clark, Erie, CO (US); Scott Anderson, Lafayette, CO (US)

(73) Assignee: Earthcore Worldwide, Inc., Lafayette, CO (US)

(21) Appl. No.: 13/185,363

(22) Filed: Jul. 18, 2011

Related U.S. Application Data
(60) Provisional application No. 61/399,767, filed on Jul. 17, 2010.

(51) Int. Cl. E04C 3/00; C09J 5/00; E04C 2/20

(52) U.S. Cl. 52/309.4; 52/834; 156/305; 52/847

(57) ABSTRACT

The present invention relates to the construction arts, in particular a new implementation for a framing member or structural support apparatus for bearing the loads required for walls, roofs, ceilings, and floors. Further a formed insulated layer with enhanced adhesion characteristics provides a thermal break within the framing member serves to increase the insulation value and enhance the structural value of the apparatus.

### CROSS REFERENCE TO RELATED APPLICATIONS

This application claims the benefit of U.S. Provisional Application No. 61/399,767 filed on 17 Jul. 2010 which is incorporated herein in its entirety.

### FIELD OF THE INVENTION

The present invention relates to load bearing static structure used in the construction arts. In particular an insulated framing member replacement for use in walls, roofs, door frames, window frames, floors and other load bearing elements where a framing member is used.

### BACKGROUND OF THE INVENTION

The foregoing examples of the related art and limitations are intended to be illustrative and not exclusive. Other limitations of the related art will become apparent to those of skill in the art upon a reading of the specification and a study of the drawings or figures as provided herein.

In construction high structural loads are carried within walls roofs, floors and ceilings of structures. A common method of carrying these loads is framing walls, roofs, floors and ceilings with framing members. These frames typically use 2×4 inch or 2×6 inch or smaller or larger framing members depending on the loads and other architectural requirements spaced to support the weight and to provide voids which may be insulated to increase the thermal insulation and sound insulation properties of the building. These framing members must carry vertical loads as well as retaining integrity during shearing, twisting, warping, and other forces caused by wind, uneven load bearing, increasing and decreasing loads, earth movement or similar forces.

Further, when a framing member directly contacts interior and exterior surface materials, it creates a thermal bridge with low beneficial insulation characteristics.

In addition, the loads and forces on framing members can cause layered material to pull apart or de-laminate over time. Adhesion under stress becomes a primary issue with manufacturing framing members from non-homogenous materials.

Prior art for the manufacture of framing members includes milling lumber, manufacturing pressed wood, manufacturing wood composites, manufacturing glued laminated lumber, manufacturing metal framing member replacements, creating synthetic framing members, and replacing framing members with composite mineral materials typically to 2×4 inch, 2×6 inch or other sizes indicated for architectural reasons. This solution does not solve the thermal bridging problems.

Recently, requirements to increase thermal insulation in structures necessitate elimination of thermal bridges between the interior and exterior walls. Typically a foam board is used over the outer wall to disrupt the thermal bridge. This foam board adds a drain plane to the wall or roof and changes the dimensions of the walls requiring redesign of the window and other openings as they relate to the plane on the wall. The use of fasteners through the foam into the framing members creates a thermal bridge decreasing the insulating value of the foam boards.

### SUMMARY OF THE INVENTION

The current invention, comprises two outside structural pieces formed with a formed insulated layer adhered to the structural pieces on either side. This apparatus and methodology provides both the structural strength and insulation benefits in the formed insulated framing member including a thermal break. The apparatus is constructed to create additional surface area for adhesion to resist delaminating. The apparatus can further provide attachment surfaces suited to nailing, gluing, screwing, stapling, and the like during subsequent construction and finish work. In addition the necessity of the foam insulation plane is eliminated as the thermal break can be completed entirely between the internal and external walls.

In one embodiment the invention comprises two pieces of timber or engineered wood 1.5″ by 1.5″ spaced 0.5″, 2.5″, or 4.5″ apart with dovetail cuts 0.25″ into the facing sides filled on the inside with polyurethane structural insulation and coated with high tensile strength 3 millimeter polyurea.

### BRIEF DESCRIPTION OF THE DRAWINGS

A complete understanding of the present invention may be obtained by reference to the accompanying drawings, when considered in conjunction with the subsequent, detailed description, in which:

FIG. 1 depicts a perspective view of a structural framing member ready for use as a stud; 20 is a structural material and 22 is an insulating material;

FIG. 2 depicts a perspective end view of a framing member illustrating three of the many adhesion area enhancing designs; 24 is a tongue, 26 is a bevel and 28 is a groove joint;

FIG. 3 depicts a cross section view of a framing member illustrating an additional adhesion areas enhancing design; 30 is an finger, 32 is an anchor and 34 a route joint;

FIG. 4 depicts a zoomed in cross section view of a framing member illustrating an adhesion area enhancing design; 36 is a radius;

FIG. 5 depicts a zoomed in cross section view of a framing member illustrating an additional adhesion area enhancing design; 38 is a notch;

FIG. 6 depicts a cross section view of a framing member for use as a column post; 48 is an elongated element bearing a polymer coating 50;

FIG. 7 depicts a zoomed cross section view of a framing member for use as a column post with various area enhancing design features; 40 is an anchor and 44 is a tooth;

FIG. 8 depicts insulated lumber with an external coating of polyurea 50

FIG. 9 depicts an elongated frame that can be subsequently cut into multiple studs

### DETAILED DESCRIPTION OF THE EMBODIMENTS

The present invention relates to an insulated lumber with enhanced adhesion between the layers of lumber and insulation. This enhanced adhesion framing element is useful for many forms of construction while not creating a thermal bridge across the structure built.

Materials for structural members used in the invention can be selected from a variety of sources including materials used commonly in the art. Lumber may be obtained from timber. Timber cut and prepared into boards planks or other ready for market pieces. Specific to this application the pieces marketed for use framing and building during construction. As used in this application, both wood; engineered wood (combined particles, strands, or veneers with a glue, polymer, composite or similar bond); steel in solid, hollow, channeled and other shapes; polymers; ceramics; and other materials used for the purpose of building and framing in the way that cut timber is traditionally used for framing and building.

Insulation is a low energy transmission material used in construction or manufacturing to slow the transfer of heat, sound, or other energy through materials. Typically strong structural materials have a high capacity to transfer heat and other energies through walls, roofs, and floors and insulation is added to structure so the combined transfer of energy is reduced and the structure becomes more energy efficient, less noisy and otherwise more comfortable. Rigid closed cell polyurethane, open cell polyurethane, ceramics, and urethane are example of insulation that could be used for insulated lumber applications. Fiberglass, rock wool, and blown cellulose are examples of insulation that do not have structural value for use in insulated lumber.

Non-planar surfaces are surfaces formed to present additional surface area for adhesion between the structural layer and the insulating layer (enhanced adhesion surfaces). For purposes of the invention, any shape formed out of or cut into a structural member, striking into or out of a structural member or affixed thereto that increases the bonding surface and adhesive bond between the structural and insulating members in insulated lumber is a non-planar surface. Common irregularities from preparing materials such as sawing into lumber by normal methods are not considered non-planar enhanced adhesion surfaces. Surfaces intentionally prepared to create enhanced adhesion by alteration through modified sawing, gouging, hammering, rough sanding or other micro-scopic on nano-level preparation are non-planar for the purpose of the invention.

In one embodiment the invention comprises two pieces of timber or engineered wood 1.5″ by 1.5″ spaced 0.5″, 2.5″, or 4.5″ apart with dovetail cuts 0.25″ into the facing sides filled on the inside with polyurethane structural insulation and coated with high tensile strength 3 millimeter polyurea.

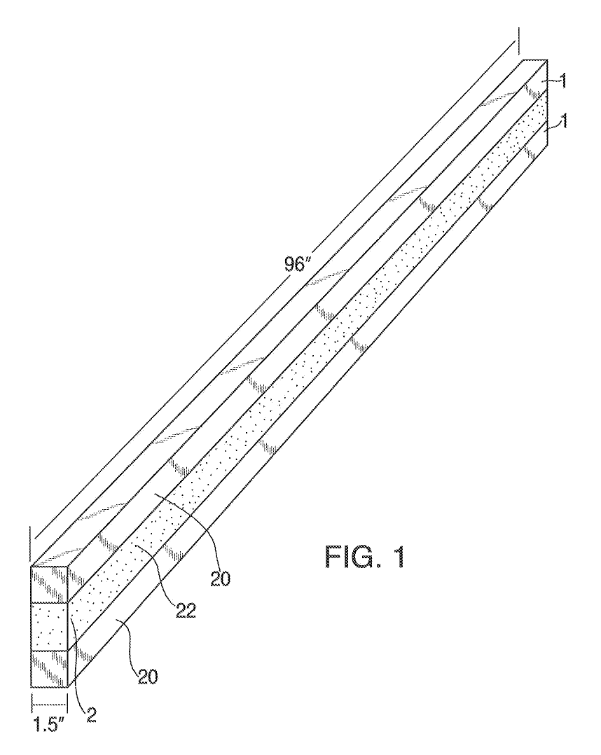

The external view of an enhanced adhesion framing element is illustrated in FIG. 1. The elongated structural material 20 runs the length of enhanced adhesion framing element and provides the majority of the mechanical properties of the enhanced adhesion framing element. The insulating material 22 provides the insulation property to the enhanced adhesion framing element, serving as a thermal break between the two elongated structural elements. The adhesion enhancement features are not visible in this external view.

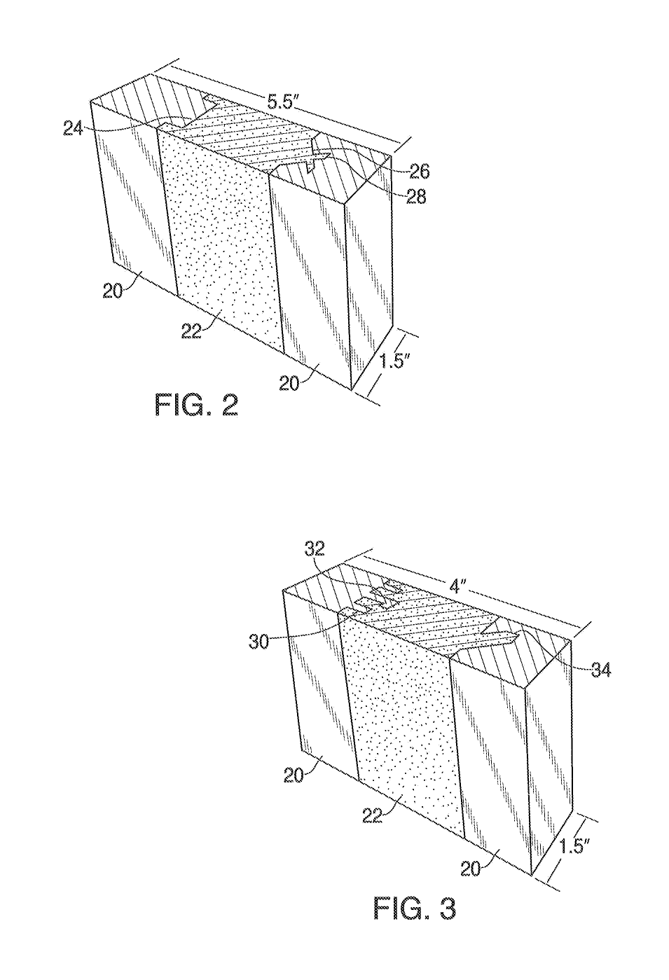

FIG. 2 illustrate a transverse cross-sectional cutaway view of the enhanced adhesion framing element according to a few different embodiments of the current invention. The structural elongated elements 20 show three different embodiments of the current invention, a tongue 24, bevels 26, and grooves 28. Each of these embodiments consists of deviations from planarity, which increase the surface area for adhesion. Likewise, these deviations from planarity give a plurality of angles to the interface of the insulating layer and the elongated structural element, ensuring that any stress applied to the enhanced adhesion framing element has at least a portion of the interface not normal to the applied stress, which is typically the weakest direction of an adhesive bond. Additionally, the grooves 28, provide a structure such that the insulation must undergo significant deformation to experience an adhesive failure, so that the composite structure strength is not limited by the adhesive strength, but instead by the cohesive strength of the insulation.

FIG. 3 illustrate a transverse cross-sectional cutaway view of the enhanced adhesion framing element according to a few different embodiments of the current invention. The structural elongated elements 20 show three different embodiments of the current invention, a finger 30, an anchor 32, and a route 34. Each of these embodiments consists of deviations from planarity, which increase the surface area for adhesion.

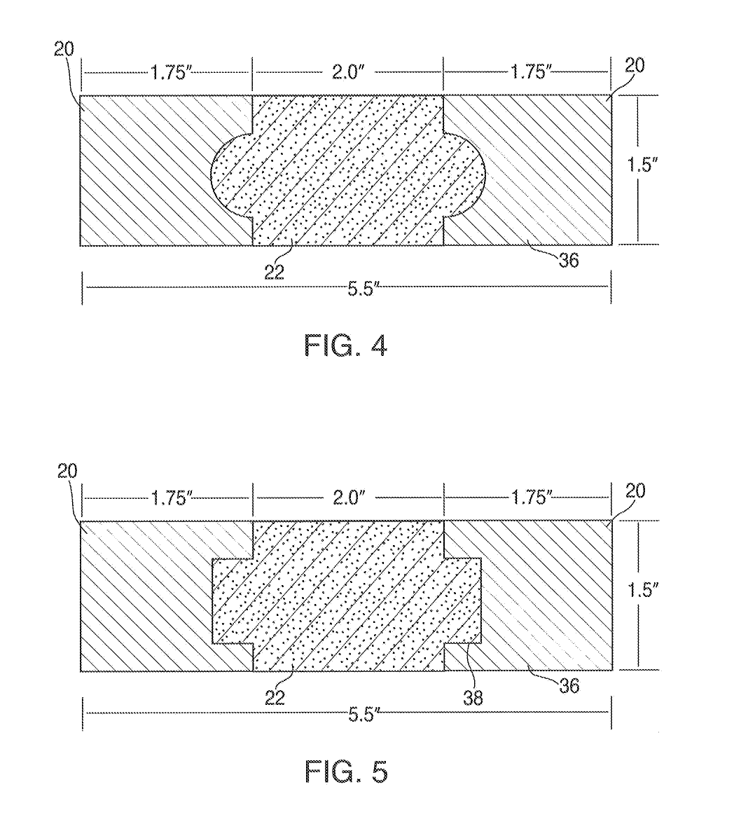

FIG. 4 illustrates a transverse cross-sectional cutaway view of the enhanced adhesion framing element according to an embodiment of the current invention. The structural elongated elements 20 each have a radius 36 cut into them. This embodiment consists of a deviation from planarity, which increase the surface area for adhesion.

FIG. 5 illustrates a transverse cross-sectional cutaway view of the enhanced adhesion framing element according to an embodiment of the current invention. The structural elongated elements 20 each have a notch 38 cut into them. This embodiment consists of a deviation from planarity, which increase the surface area for adhesion.

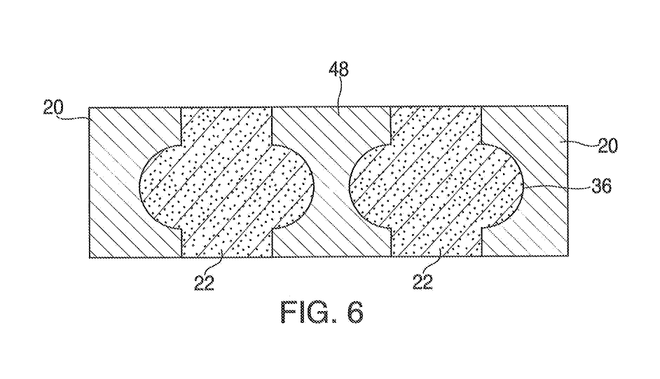

FIG. 6 illustrates a transverse cross-sectional cutaway view of the enhanced adhesion framing element according to an embodiment of the current invention. The structural elongated elements 20 each have a radius 36 cut into them. This embodiment consists of a deviation from planarity, which increase the surface area for adhesion. Additionally an internal structural elongated element 48 is shown such that it has deviations from planarity shown on both sides. The introduction of internal structural elements also creates an additional insulation layer.

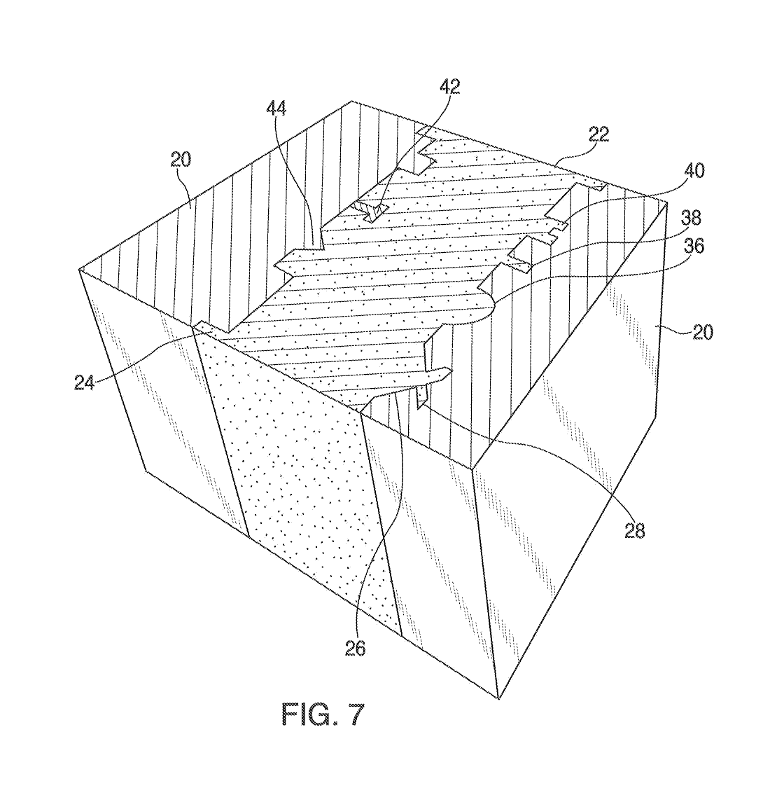

FIG. 7 illustrates a transverse cross-sectional cutaway view of the enhanced adhesion framing element according to several different embodiments of the current invention. The figure shows that many different embodiments many be combined together on the same enhanced adhesion framing element. Additional embodiments not shown in the previous figures are an anchor 42 and a tooth 44. Each of these embodiments consists of a deviation from planarity, which increase the surface area for adhesion.

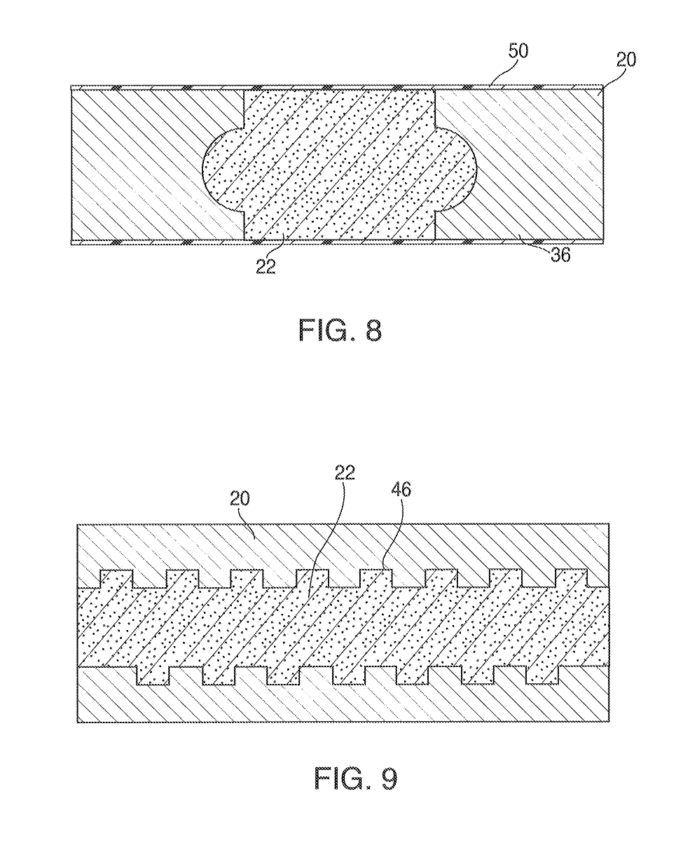

FIG. 8 illustrates a transverse cross-sectional cutaway view of the enhanced adhesion framing element according to an embodiment of the current invention. The structural elongated elements 20 each have a radius 36 cut into them. This embodiment consists of a deviation from planarity, which increases the surface area for adhesion. Additionally the enhanced adhesion framing element is coated with a polyurea coating 50 for the enhancement of mechanical properties. While the coating here is shown as a polyurea, it could be alternatively any coating which enhances the mechanical property of the enhanced adhesion framing element or seals and protects the insulation layer, such as polyurethane, epoxy, or acrylic coatings.

FIG. 9 illustrates a transverse cross-sectional cutaway view of the enhanced adhesion framing element according to an embodiment of the current invention. The structural elongated elements 20 each have a plurality of dovetails 46 cut into them. This embodiment consists of a deviation from planarity, which increase the surface area for adhesion. Additionally this enhanced adhesion framing element can be cut into a plurality of smaller enhanced adhesion framing elements.

### Example 1

An enhanced adhesion framing element is prepared cut cutting 12.7 mm deep dovetails into 2 pieces of laminated veneer lumber. The two pieces of laminated veneer lumber are held 76 mm apart, with the dovetail surfaces facing each other. A polyurethane rigid foam insulation (SWD 4 pound rigid foam) is poured in the cavity and allowed to rise and fill the cavity including the dovetails. The foam density was measured at 106 kg/m³. After the foam was cured, the enhanced adhesion framing element was cut into pieces about 38 mm wide, to serve as a replacement for 2×6 structural lumber.

Samples were prepared and tested per ASTM D 1623, tensile strength. These samples were so that the lumber is on both ends of the specimen and polyurethane rigid foam insulation is in the center. The lumber and polyurethane interface has to bear the entire tensile load. The samples show failure deep in the foam layer near the dovetail. However, in the substantially planar region of the lumber, the foam fails very near the adhesion layer, indicating that the skin layer is the weakest part of the composite structure. The presence of the dovetail therefore strengthens the composite.

### Example 2

An enhanced adhesion framing element is prepared cut cutting 12.7 mm deep dovetails into 2 pieces of laminated veneer lumber. The two pieces of laminated veneer lumber are held 76 mm apart, with the dovetail surfaces facing each other. A polyurethane rigid foam insulation (SWD 4 pound rigid foam)is poured in the cavity and allowed to rise and fill the cavity including the dovetails. The foam density was measured at 106 kg/m³. After the foam was cured, the enhanced adhesion framing element was cut into pieces about 38 mm wide, to serve as a replacement for 2×6 structural lumber.

Samples were prepared and tested per ASTM C 273, shear strength. These samples are cut so that load is applied on one side the lumber and the other side to the polyurethane rigid foam so that the interface of the lumber and the polyurethane rigid foam insulation has to bear the entire shear load. The samples show failure deep in the foam layer near the dovetail. However, in the substantially planar region of the lumber, the foam fails very near the adhesion layer, indicating that the skin layer is the weakest part of the composite structure. The presence of the dovetail therefore strengthens the composite.

### Example 3

An enhanced adhesion framing element is prepared cut cutting 12.7 mm deep dovetails into 2 pieces of lumber. The two pieces of lumber are held 76 mm apart, with the dovetail surfaces facing each other. A polyurethane rigid foam insulation (SWD 4 pound rigid foam) is poured in the cavity and allowed to rise and fill the cavity including the dovetails. The foam density was measured at 75 kg/m³. After the foam was cured, the enhanced adhesion framing element was cut into pieces about 38 mm wide, to serve as a replacement for 2×6 structural lumber.

After cutting, some of the enhanced adhesion framing elements were coated with a polyurea spray coating, Elastocast 72330 supplied by BASF Corporation. The coating was applied at a thickness of about 0.5 mm.

Samples were prepared and tested per ASTM D 1623, tensile strength. These samples were so that the lumber is on both ends of the specimen and polyurethane rigid foam insulation is in the center. The samples of enhanced adhesion framing element without the polyurea coating had a tensile strength of 580 kPa. The samples of enhanced adhesion framing element with the polyurea coating had a tensile strength of 943 kPa.

What is claimed is:

1. A formed framing member bearing an outer surface for construction framing comprising:
two exterior elongated structural members with deviations from plane on the inside facing surface areas of said elongated structural members to provide enhanced adhesion of an insulating layer, and,
a formed insulating material between and adhering to the said inside facing surfaces of said elongated structural members.

2. A formed framing member in accordance with claim 1 wherein said elongated structural member is between 1 mm and 160 mm in thickness.

3. A formed framing member in accordance with claim 1 wherein the material of said structural member is wood, laminated strand lumber (LSL), laminated veneer lumber (LVL), micro laminated lumber, oriented strand board (OSB), plywood, pressed wood, laminated layered board, synthetic wood, carbon fiber board, magnesium oxide board, steel, aluminum, alloy, cement board or hardboard.

4. A formed framing member in accordance with claim 1 wherein said insulating material is polyurethane foam, urethane foam, isocyanurate foam, polypropylene foam, styrene foam, polystyrene foam, Styrofoam insulation, evacuated microsphere foam, fiberglass foam, plastic foam, ceramic foam, silicon foam, carbon foam, composite foam, alloy foam or a rigid formed solid (non-foaming) insulator made of urethane, polypropylene, plastic, ceramic, composite, mineral, alloy or combinations thereof.

5. A formed framing member in accordance with claim 1 wherein said deviation from plane comprises raised structural features.

6. A formed framing member in accordance with claim 1 wherein said deviation from plane is a concave, convex, undulating, saw-toothed or jagged.

7. A formed framing member in accordance with claim 1 wherein said deviation from plane is a shape utilizing a dovetail, ridge, tab, anchor, finger, cone, shelf, half shelf, groove, cut, slot, trench, tongue, bevel, hole, tunnel, spike, dado, route or gouge.

8. A formed framing member in accordance with claim 1 wherein the external surfaces are coated.

9. A formed framing member in accordance with claim 5 wherein the some external surfaces are coated.

10. A formed framing member in accordance with claim 6 wherein the external surfaces of the insulation are coated.

11. A formed framing member in accordance with claim 5 wherein the coating consists of polyurea, polyurethane, epoxy, polyester, or acrylic.

12. A formed framing member in accordance with claim 1 wherein said framing member further comprises a stud.

13. A formed framing member in accordance with claim 1 wherein said framing member further comprises a beam.

14. A formed framing member in accordance with claim 1 wherein said framing member further comprises a header.

15. A formed framing member in accordance with claim 1 wherein said framing member further comprises a column post.

16. A formed framing member in accordance with claim 1 wherein said framing member further acts as a spline connector between two or move structural insulated panels.

17. A formed framing member in accordance with claim 1 wherein said framing member further comprises at least one of a rim, ridge, shelf, ledge, sill, step, or cleat.

18. A formed framing member in accordance with claim 1 wherein said framing member contains deviations from plane on edges other than the adhesion enhanced edges to comprise at least one spline joint, locking cam, tongue, groove, mortise, tenon, rebate, rabbet, lock joint, dado, overlap, slot, or trench.

19. A formed framing member in accordance with claim 1 wherein the appearance of the intersection of the structural and insulating materials is a plane from afar, where nanotechnology or small deviations from plane for adhesion enhancement are apparent under close inspection or magnification.

20. A formed framing member for construction framing said framing member comprising:(i) two exterior elongated structural members, (ii) with deviations from plane on the inside areas to provide enhanced adhesion of an insulating layer, and (iii) a plurality of alternating insulating material and structural members layers.

21. A formed framing member in accordance with claim 3 wherein a variety of foams or a plurality of densities of one foam are used to provide desired structural or insulating value.

22. A formed framing member in accordance with claim 4 wherein the convex shape or anchor is hollow and is itself filled with insulating material or used as an insulating void.

23. A method for making a framing member comprising the steps of: (i) providing two elongated structural members;(ii) encasing the structural members under resistive pressure; (iii); filling the void with adhesive insulation; and, (iv) curing the insulation.
